(19) United States
(12) Patent Application Publication
(10) Pub. No.: US 2025/0308532 A1
(43) Pub. Date: Oct. 2, 2025

(54) METHOD FOR SUPPORTING THE HEARING COMPREHENSION OF A HEARING INSTRUMENT USER AND HEARING SYSTEM WITH A HEARING INSTRUMENT

(71) Applicant: Sivantos Pte. Ltd., Singapore (SG)

(72) Inventor: Florian Josef RETTELBACH, Erlangen (DE)

(21) Appl. No.: 19/087,830

(22) Filed: Mar. 24, 2025

(30) Foreign Application Priority Data
Mar. 26, 2024 (DE) 10 2024 202 870.3

(51) Int. Cl. G10L 15/26; G06T 11/60; G10L 13/033; G10L 25/78

(52) U.S. Cl. CPC G10L 15/26; G06T 11/60; G10L 13/0335; G10L 25/78

(57) ABSTRACT

A method for supporting hearing comprehension of a hearing instrument user includes using the hearing instrument to capture speech-containing ambient sound from surroundings. The speech is automatically converted into text data output to the user as a graphical representation of text on a screen of the hearing instrument or peripheral device connected thereto for data transmission and/or as synthesized speech as a sound signal. A direction of origin and/or at least one speaker trait for the speech are/is determined automatically and resolved relative to time. The graphical representation of the text data and synthesized speech vary based on the identified direction of origin and/or speaker trait in a manner resolved relative to time. Additionally or alternatively to immediate output to the user, the graphical representation of the text data and synthesized speech are recorded for later output. A hearing system is also provided.

The invention relates to a method for supporting the hearing comprehension of a hearing instrument user. The invention further relates to a hearing system comprising such a hearing instrument.

A hearing instrument generally refers to an electronic device that supports the ability of a person wearing the hearing instrument (who is referred to as a “wearer” or “user” below) to hear. In particular, the invention relates to hearing instruments that are configured to fully or partly compensate for a loss of hearing in a user with impaired hearing. Such a hearing instrument is also referred to as a “hearing device”. Additionally, there are hearing instruments that are meant to protect or improve the ability of users with normal hearing to hear, e.g. in loud, demanding or complex hearing situations.

Hearing instruments in general, and hearing devices specifically, are usually designed to be worn on the head and in this case in particular in or on an ear of the user, in particular as behind-the-ear devices (BTE devices) or in-the-ear devices (ITE devices). In terms of their internal structure, hearing instruments routinely comprise at least one (acousto-electric) input transducer, a signal processing unit (signal processor) and an output transducer. During operation of the hearing instrument, the or each input transducer captures airborne sound from the surroundings of the hearing instrument and converts this airborne sound into an input audio signal (i.e. an electrical signal that transports information about the ambient sound). This at least one input audio signal is also referred to as a “captured sound signal” below. The or each input audio signal is processed (i.e. has its sound information modified) in the signal processing unit in order to support the ability of the user to hear, in particular to compensate for a loss of hearing in the user. The signal processing unit outputs an accordingly processed audio signal (also referred to as an “output audio signal” or a “modified sound signal”) to the output transducer. In other embodiments, the hearing instrument may also be in the form of a handheld device or in the form of a tabletop device. By way of example, the output transducer may be formed by headphones (connected to the handheld device or tabletop device by wire or wirelessly).

In most cases, the output transducer is in the form of an electro-acoustic transducer that converts the (electrical) output audio signal back into airborne sound, this airborne sound-which is modified in comparison with the ambient sound-being delivered to the auditory canal of the user. In the case of a hearing instrument worn behind the ear, the output transducer, also referred to as a “receiver”, is usually integrated in a housing of the hearing instrument outside of the ear. The sound that is output by the output transducer is guided into the auditory canal of the user by means of a sound tube in this case. As an alternative thereto, the output transducer can also be arranged in the auditory canal, and consequently outside of the housing worn behind the ear. Such hearing instruments are also referred to as RIC devices (from “receiver in canal”). Hearing instruments worn in the ear, which are dimensioned to be so small that they do not protrude beyond the auditory canal to the outside, are also referred to as CIC devices (from “completely in canal”).

In other designs, the output transducer can also be in the form of an electromechanical transducer that converts the output audio signal into structure-borne sound (vibrations), this structure-borne sound being delivered to the cranial bone of the user, for example. Further, there are implantable hearing instruments, in particular cochlear implants, and hearing instruments whose output transducers directly stimulate the auditory nerve of the user.

The term “hearing system” denotes an individual device or a group of devices and possibly non-physical functional units, which together provide the functions required during operation of a hearing instrument. In the simplest case, the hearing system can consist of a single hearing instrument. As an alternative thereto, the hearing system can comprise two cooperating hearing instruments for taking care of both ears of the user. In this case, reference is made to a “binaural hearing system”. Additionally or alternatively, the hearing system can comprise at least one further electronic device, for example a remote control, a charger or a programming device for the or each hearing instrument. In the case of modern hearing systems, a control program, in particular in the form of a so-called app, is often provided instead of a remote control or a dedicated programming device, this control program being designed for implementation on an external computer, in particular a smartphone or tablet. The external computer itself is routinely not part of the hearing system in this case, inasmuch as it is generally provided independently of the hearing system and not by the manufacturer of the hearing system either. Rather, the external computer, in particular the smartphone of the user, is used by the hearing system only as an external resource for processing power, storage space and optionally communication services.

Users of hearing instruments often have problems understanding (spoken) speech in their surroundings (e.g. speech from interlocutors or speech sound from sound reproduction devices, e.g. radios or televisions). In the case of hearing device users, this is regularly due to a hearing impairment in the user that can often be compensated for only in part even by modern hearing device technology. In the case of users with normal hearing too, supporting or even improving hearing comprehension by way of a hearing instrument is a complex problem. In both cases, hearing comprehension is often hampered by disruptive background noise (in particular conversation noise), unclear pronunciation or pronunciation that is unfamiliar to the user (e.g. use of an accent or a dialect).

The invention is based on the object of effectively supporting the hearing comprehension of a hearing instrument user (that is to say the ability of the user to understand speech that is heard).

In regard to a method for supporting the hearing comprehension of a hearing instrument user, this object is independently achieved according to the invention by the features of claims 1 and 3. In regard to a hearing system, the object is independently achieved according to the invention by the features of claims 9 and 10. Advantageous configurations or developments of the invention, some of which are inventive on their own, are presented in the dependent claims and the description that follows.

According to the method, the hearing instrument is used to capture speech-containing ambient sound from the surroundings of the user. Speech contained in the captured ambient sound is automatically detected and converted into text data. The text file is preferably generated in the form of alphanumeric characters using a data-systems encoding. As an alternative thereto, however, the text file for the detected speech can also be generated in an alternative form, e.g. in the form of phonemes, syllables, words and/or clauses (differing from alphanumeric characters) using data-systems encoding.

In a first variant of the inventive method, these text data are output as a graphical representation of text on a screen. The screen may, in principle, be an intrinsic part of the hearing instrument within the context of the invention, e.g. if the hearing instrument is in the form of a handheld device or tabletop device. Preferably (in particular in the case of hearing instruments worn on or in the ear), however, the text data are output via a screen of a peripheral device connected to the hearing instrument for data transmission purposes (e.g. the smartphone or a smartwatch of the user, connected to the hearing instrument).

In a second variant of the inventive method, the text data are converted into synthesized speech and output to the user in the form of a sound signal. The output in this case is preferably produced via the at least one output transducer of the hearing instrument. The original speech sound contained in the ambient sound is attenuated or completely masked out, preferably by mechanical and/or signal-processing means, upon and during output of the synthesized speech. Optionally, instead of the natural ambient sound, artificially generated ambient sounds (noise, birdsong, music) are added to the synthesized speech in order to artificially generate a sound situation that seems natural and therefore avoid possibly irritating the user.

To support hearing comprehension particularly effectively, in both variants of the invention a direction of origin and/or at least one speaker trait (more precisely characterizing the speaker) for the speech contained in the ambient sound are/is determined automatically and in a manner resolved with respect to time.

According to the invention, the graphical representation of the text data derived from the ambient sound and the synthesized speech are varied on the basis of the identified direction of origin and/or the at least one speaker trait in a manner resolved with respect to time.

Direction of origin refers to the direction of incidence of the speech sound contained in the ambient sound relative to the head of the user (in particular relative to the viewing direction of the user). Analysis is thus performed—preferably using adaptive directional sound capture (adaptive beamforming)—to ascertain the location from which the speech contained in the ambient sound is incident. Speaker traits (or voice traits) generally refer to traits of the voice contained in the ambient sound that can be used to characterize at least one personal trait of the respective speaker and that can therefore be used to distinguish the speaker from other speakers. By way of example, the at least one speaker trait is selected from voice timbre, tonal pitch (i.e. the pitch of the fundamental tone of the voice) or speech rate or—derived from the analysis of the voice—an assumption about the sex and/or age of the user.

The text data and the synthesized speech are preferably output to the user in real time, i.e. without distinctly noticeable delay compared to the captured ambient sound. Output by means of synthesized speech results in the output being produced preferably with a delay of no more than 0.2 second, preferably no more than 0.1 second. Graphical written output of the text data on a screen can result in the output being produced with a longer delay compared to the ambient sound, without the delay being perceived by the user as annoying, since the text data in the graphical written output can be grasped more quickly compared to the spoken speech. The output of the text data in this case is preferably produced with a delay of no more than 0.5 second, in particular no more than 0.3 second, following capture of the speech sound.

Two further variants of the inventive method are akin to the above-described first and second variants of the inventive method, with the difference that the text data derived from the spoken speech are not output to the user immediately in this case. Rather, the text data are recorded (i.e. stored) for later output in this case. In a third variant of the inventive method, this recording—analogously to the first variant of the invention—is produced in graphical written form by virtue of the text data being recorded as a graphical representation of text. In a fourth variant of the inventive method, the recording—analogously to the second variant of the invention—is produced in sonic form by virtue of the text data in this case being recorded as synthesized speech in an audio signal (that is to say a data signal containing sound information).

The third and fourth variants of the inventive method, too, involve the direction of origin and/or the at least one speaker trait for the speech contained in the ambient sound being determined automatically and in a manner resolved with respect to time, the graphical representation of the text data and the synthesized speech in turn being varied on the basis of the identified direction of origin and/or the at least one speaker trait in a manner resolved with respect to time.

The four above-described variants of the invention can be used individually or in any combination with one another within the context of the invention. By way of example, the text data derived from the ambient sound can be output only as graphical written text, only as synthesized speech, or in both forms simultaneously. Furthermore, the text data can be either only output directly to the user, only recorded for later output, or both output immediately and recorded within the context of the invention.

In order to adapt the graphical written output or recording of the text data according to the direction of origin of the speech sound, a display location for the text data on a display surface is preferably varied on the basis of the direction of origin in a manner resolved with respect to time. By way of example, the text derived from the ambient sound is displayed in a left-hand region of the display surface, in the middle of the display surface or in a right-hand region of the display surface whenever and while the identified direction of origin reveals that the associated speaker—as seen in the viewing direction of the user—is arranged to the left of the user or opposite and in front of the user or to the right of the user. The display location of the text data is changed when the direction of origin of the speech sound changes due to a change of speaker, a movement by the speaker or a movement by the user (in particular a head movement).

As an alternative or in addition thereto, a direction-indicating symbol associated with the text (e.g. an arrow or a speech bubble stem of a speech bubble containing the text data) is preferably changed depending on the direction of origin of the speech sound. By way of example, the direction-indicating symbol points to the left, downward (or upward) or to the right when and while the identified direction of origin reveals that the associated speaker is situated to the left of the user or opposite and in front of the user or to the right of the user.

In a particularly intuitive embodiment of the invention, the graphical written output or recording of the text data is produced in the form of a virtual reality representation (VR representation) by virtue of the text data being inserted into a real image sequence (video) of the surroundings of the user that is captured during capture of the ambient sound. The text insertion in this case is locally associated with a depiction of a related sound source in the real image sequence in accordance with the identified direction of origin of the speech sound. In other words, the text data containing the speech are inserted in the real image sequence in each case at the depicted location or close to the depicted location from which the speech sound emanates in the real surroundings. If the speech sound is generated by a speaking person in the surroundings of the user, the text data in the real image sequence (e.g. in the form of a speech bubble) are displayed close to the depiction of this person. If the speech sound, according to the direction of origin, emanates from a sound reproduction device (e.g. a radio or television), the text data are accordingly displayed close to this device. If the direction of origin changes—e.g. due to a change of speaker, a movement by a speaker or a movement by the user (or by an image capture device of the user)—the location of the text insertion in the real image sequence is also changed accordingly. The text data associated with a person or with a device thus always accompany the depiction of this person or of this device in the real image sequence.

In another embodiment of the invention, speech from different speakers is visually distinguished from one another by way of a different graphical written appearance of the respective related text data, e.g. by selecting the text color, text size, font and/or a background color of an associated text box. This graphical written appearance for the output or recording of the text data is in turn varied in a manner resolved with respect to time. By way of example, text data associated with a first speaker are always displayed in a text box with a red background, while text data associated with a second speaker are always displayed in a text box with a blue background. The distinction between different speakers, within the context of the invention, can be made on the basis of the respective direction of origin of the speech contained in the ambient sound; wherein, by way of example, an abrupt change in the identified direction of origin is recognized as an indication of a change of speaker. Preferably, however, the distinction between different speakers is made-exclusively or in addition to evaluation of the direction of origin-on the basis of the at least one detected speaker trait. In this case, analysis of the respective voice used to speak the speech contained in the ambient sound, e.g. on the basis of voice timbre, tonal pitch and/or speech rate, is used to recognize different speakers and distinguish them from one another. The graphical written appearance of the text data is varied accordingly to adapt it to the particular recognized speaker.

In order to adapt the output or recording of the synthesized speech according to the direction of origin of the sound signal, the sound or audio signal containing the synthesized speech is preferably generated as a stereo signal with a variable stereophonic sound characteristic that always corresponds exactly or approximately to the stereophonic sound characteristic of the speech sound. The sound or audio signal containing the synthesized speech is thus generated—in particular by setting the same or a different volume, time delay and/or timbre of the right and left stereo signal elements—in such a way that the synthesized speech appears, in the perception of the user, to come from the direction of origin identified for the original speech sound. This stereophonic sound characteristic is produced in particular by applying a head-related transfer function to the synthesized speech.

Additionally or alternatively, the voice timbre and/or tonal pitch of the sound or audio signal for the output or recording of the synthesized speech are/is preferably varied on the basis of the at least one speaker trait in a manner resolved with respect to time. The synthesized speech is in particular matched approximately to the traits of the original speech sound and changed accordingly in the event of a change of speaker. By way of example, the synthesized speech is generated as a female, male or child's voice when and while the original speech in the ambient sound, according to the vocal sound, is also spoken by a woman or a man or a child.

In principle, the automatic detection of the speech contained in the ambient sound and the graphical written or sonic reproduction and/or recording can take place, within the context of the invention, whenever and while the ambient sound contains speech; this therefore includes when the user themself is speaking. Preferably, however, these method steps are applied only to speech that does not come from the user themself. These method steps are therefore preferably not carried out when and while the user themself is speaking. This is because these method steps would not afford any advantage for the user's own speech, since the user knows what they are saying, of course.

The inventive hearing system is generally configured to automatically perform the above-described inventive method in one of the described method variants. The above-described embodiments of the inventive method therefore correspond to applicable embodiments of the inventive hearing system. The above explanations with regard to the inventive method and the associated effects and advantages are applicable, mutatis mutandis, to the inventive hearing system, and vice versa.

The hearing system comprises at least one hearing instrument that in turn has at least one input transducer (preferably multiple input transducers), a signal processor and an output transducer. The or each input transducer is used for capturing ambient sound from the surroundings of the user, i.e. for converting the ambient sound into an (input) audio signal, which is supplied to the signal processor. The signal processor is used for modifying the captured sound signal. The modification of the captured sound signal by the signal processor preferably comprises frequency-selective amplification of the captured sound signal (in particular to completely or partially compensate for a hearing impairment in the user). An (output) audio signal that is output by the signal processor—and which contains accordingly modified sound information—can be supplied to the output transducer in order to be output to the user by the latter.

To perform the inventive method, the hearing system additionally comprises a speech detection unit, an analysis unit and a text composing and editing unit.

The speech detection unit is configured to automatically convert speech contained in the captured ambient sound into text data. The analysis unit is configured to determine the direction of origin and/or the at least one speaker trait for the speech contained in the ambient sound automatically and in a manner resolved with respect to time. The text composing and editing unit is configured to compose and edit the text data for output and/or recording.

In variants of the hearing system that are based on the first and second variants of the inventive method, the text composing and editing unit is configured to output the text data to the user as a graphical representation of text on a screen of the hearing instrument or of a peripheral device connected thereto for data transmission purposes and/or as synthesized speech in the form of a sound signal, and—as described more precisely using the inventive method—to vary the graphical representation and the synthesized speech on the basis of the identified direction of origin and/or the at least one speaker trait in a manner resolved with respect to time.

In other variants of the hearing system, based on the third and fourth variants of the inventive method, the text composing and editing unit is configured to record the text data for later output as a graphical representation of text and/or as synthesized speech in the form of an audio signal, and in turn to vary the graphical representation of the text data and the synthesized speech on the basis of the identified direction of origin and/or the at least one speaker trait in a manner resolved with respect to time.

The configuration of the hearing system for automatically performing the inventive method is program-oriented and/or circuit-orientated in nature. The inventive hearing system thus comprises program-oriented means (software) and/or circuit-oriented means (non-programmable hardware, e.g. in the form of an ASIC) that automatically perform the inventive method during operation of the hearing system. The program-oriented and circuit-oriented means for performing the method may be arranged exclusively in the hearing instrument (or hearing instruments) of the hearing system. Alternatively, the program-oriented and circuit-oriented means for performing the method are distributed over the hearing instrument or hearing instruments and also at least over a further device or a software component of the hearing system. By way of example, program-oriented means for performing the method are distributed over the at least one hearing instrument of the hearing system and also over a control program of the hearing system, the latter being installed on an external electronic device (in particular a smartphone). As mentioned above, the external electronic device itself is generally not part of the hearing system.

The or each hearing instrument of the hearing system is present in particular in one of the designs described at the outset (BTE device with internal or external output transducer, ITE device, e.g. CIC device, hearing implant, in particular cochlear implant, hearable, etc.). In the case of a binaural hearing system, the two hearing instruments of the hearing system are preferably of identical design.

The or each of the input transducer(s) is in particular an acousto-electric transducer (that is to say a microphone) that converts airborne sound from the surroundings into an electrical input audio signal. The or each output transducer is preferably in the form of an electro-acoustic transducer (receiver) that in turn converts the audio signal modified by the signal processing unit into airborne sound. Alternatively, the output transducer is designed to deliver structure-borne sound or to directly stimulate the auditory nerve of the user.

Exemplary embodiments of the invention are outlined more precisely below with reference to a drawing, in which:

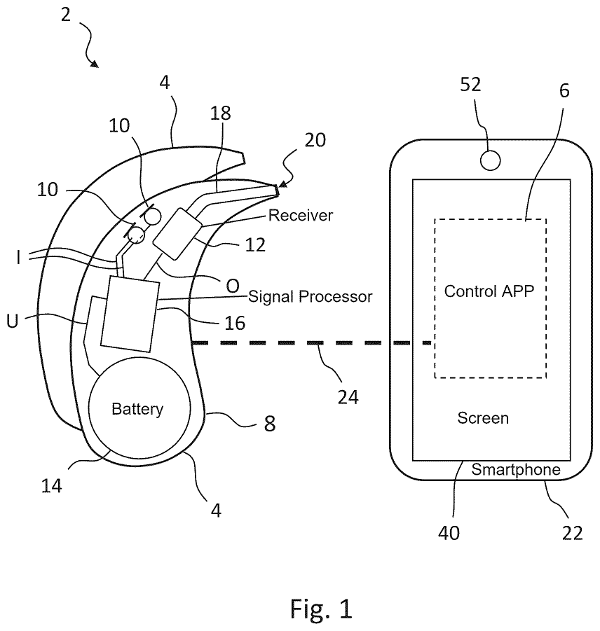

FIG. 1 shows a schematic representation of a binaural hearing system formed from two hearing instruments and a control program (control app), the hearing instruments being in the form of BTE devices, and the control program being installed on a smartphone (which is not part of the hearing system),

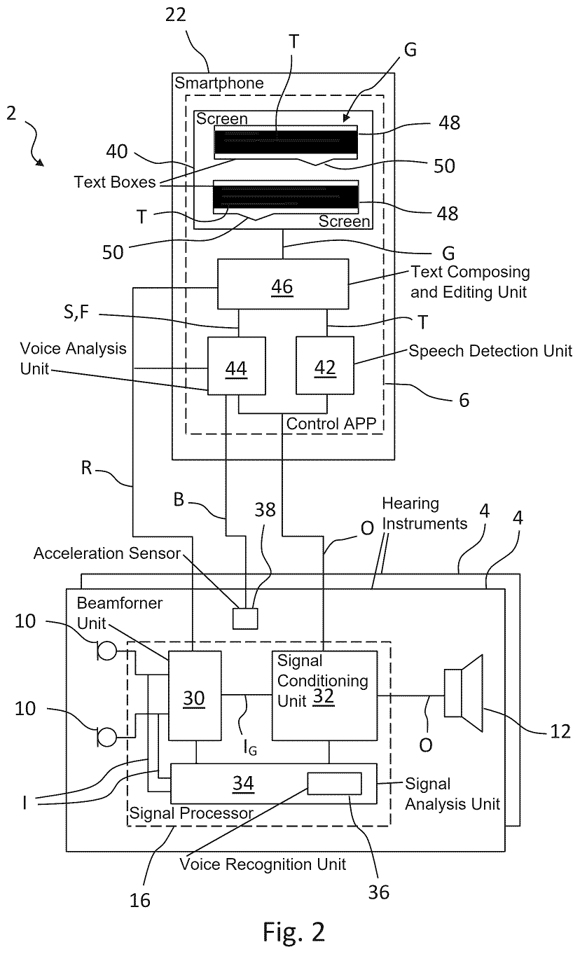

FIG. 2 shows a schematic representation of the hearing system in a first variant embodiment, in which detection of speech in the ambient sound captured by the hearing instruments results in the detected speech being automatically converted into text data, and in which the text data are output to the user by means of the control app as a graphical representation of text on a screen of the smartphone, a direction of origin of the speech being determined automatically and in a manner resolved with respect to time, and the output of the text data being varied on the basis of the identified direction of origin by virtue of text sequences with a different direction of origin each being displayed in text boxes with an indicative arrow that varies locally on the basis of the direction of origin,

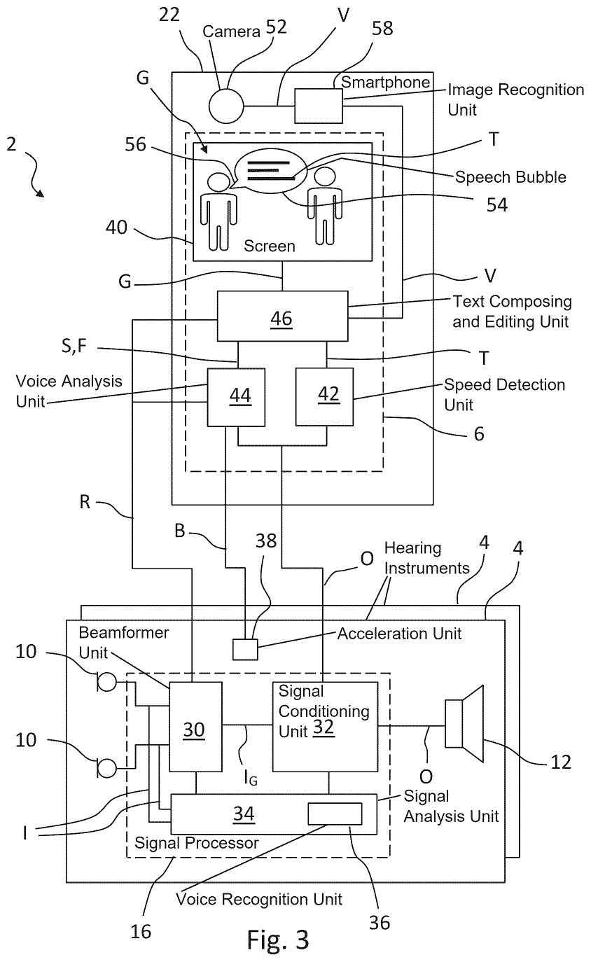

FIG. 3 shows a representation, according to FIG. 2, of the hearing system in a second variant embodiment, in which the output of the text data is varied on the basis of the identified direction of origin by virtue of text sequences being inserted into a real image sequence, captured by means of the smartphone, of the surroundings of the user, in each case in spatial association with an associated sound source, in particular an associated speaker, and

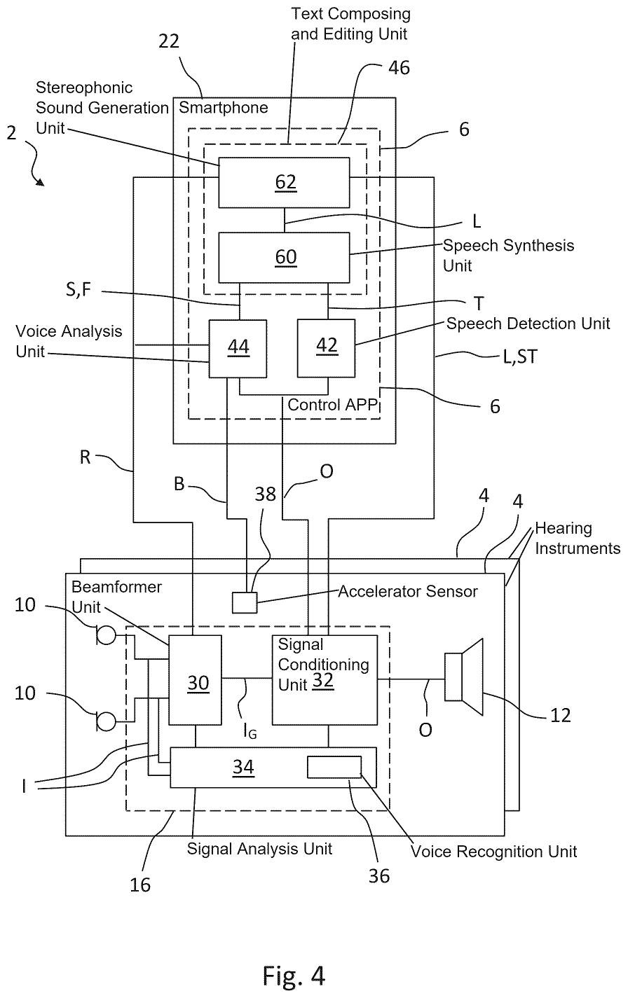

FIG. 4 shows a representation, according to FIG. 2, of the hearing system in a third variant embodiment, in which the text data are converted into synthesized speech and output to the user via the hearing instruments in the form of a sound signal, the sound signal being generated on the basis of the direction of origin as a stereo signal with a stereophonic sound characteristic that corresponds at least approximately to the stereophonic sound characteristic of the ambient sound.

Mutually corresponding parts and quantities are always provided with identical reference signs throughout all the figures.

FIG. 1 shows a hearing system 2 that (in the general case) comprises at least one hearing instrument 4, in particular a hearing device configured to support the ability of a user with impaired hearing to hear. As an optional component, the hearing system 2 shown in FIG. 1 also comprises a second hearing instrument 4 for taking care of the second ear of the user, which, in terms of its internal design, is in particular in mirrored form, but otherwise of identical design, with respect to the other hearing instrument 4. The hearing instruments 4 in the example shown in this case are BTE hearing instruments that can be worn behind the ears of the user. As a further optional component, the hearing system 2 shown in FIG. 1 comprises a control program, referred to as “control app” 6 below.

Each of the two hearing instruments 4 comprises, within a housing 8, two microphones 10 as input transducers and a receiver 12 as an output transducer. The or each hearing instrument 4 also comprises a battery 14 and a signal processing section in the form of a signal processor 16. Preferably, the signal processor 16 comprises both a programmable subunit (for example a microprocessor) and a non-programmable subunit (for example an ASIC).

The signal processor 16 is supplied with a supply voltage U from the battery 14.

During normal operation of the hearing instrument 4, each of the microphones 10 captures airborne sound from the surroundings of the respective hearing instrument 4. The microphones 10 each convert the sound into an (input) audio signal I that contains information about the captured sound. The input audio signals I are supplied, within the hearing instrument 4, to the signal processor 16, which modifies these input audio signals I in order to support the ability of the user to hear.

The signal processor 16 outputs an output audio signal O containing information about the processed and therefore modified sound to the receiver 12.

The receiver 12 converts the output sound signal O into modified airborne sound. This modified airborne sound is transmitted to the auditory canal of the user via a sound channel 18, which connects the receiver 12 to a tip 20 of the housing 8, and via a flexible sound tube (not shown explicitly), which connects the tip 20 to an earmold inserted into the auditory canal of the user.

The control app 6 in the example according to FIG. 1 is installed so as to be executable in a smartphone 22 of the user. The smartphone 22 is itself not part of the hearing system 2. The control app 6 is used, among other things, as a remote control and a programming device for the hearing instruments 4 of the hearing system 2. To this end, it is connected to the hearing instruments 4 via a wireless data transmission connection 24 during operation of the hearing system 2 for the purpose of bilateral data interchange, in particular on the basis of the Bluetooth standard. The control app 6 accomplishes this by accessing a transmission/reception unit (transceiver), not shown explicitly, of the smartphone 22, which sets up the data transmission connection 24 to a transmission/reception unit, also not explicit, of the respective hearing instrument 4.

FIG. 2 schematically shows functional components of a first variant embodiment of the hearing system 2 in greater detail. Accordingly, the signal processor 16 of each hearing instrument 4 comprises a directional analysis unit (also referred to as a beamformer unit 30) that uses adaptive beamforming or a plurality of differently aligned beamformers to determine the direction of incidence of the respective dominant sound component (and thus the arrangement of the dominant sound source relative to the viewing direction of the user, i.e. the front direction of the head). The beamformer unit 30 can be an electronic hardware circuit. Preferably, however, the beamformer unit 30 is implemented as a software component in the signal processor 16. In addition to the input audio signals I of its own microphones 10 (that is to say the microphones 10 of the hearing instrument 4 in which the beamformer unit 30 is implemented), the beamformer unit 30 of each hearing instrument 4 optionally also takes into consideration (in a manner that is not shown explicitly) the input audio signals of the microphones 10 of the respective other hearing instrument 4. To this end, the input audio signals I are, if appropriate, wirelessly interchanged between the hearing instruments 4.

The beamformer unit 30 of each hearing instrument 4 firstly outputs a directional input audio signal I_{G}, which is supplied to a downstream signal conditioning unit of the signal processor 16. Secondly, the beamformer unit 30 outputs an origin signal R indicating the origin (direction of incidence) of the respective dominant sound component, e.g. in the form of an angle of incidence relative to the front direction of the head in the transverse plane of the head. If there is voice activity in the ambient sound, the dominant sound component is typically (at any rate predominantly) formed by the speech contained in the ambient sound.

The signal conditioning unit 32 comprises at least one signal processing algorithm, but preferably a multiplicity of signal processing algorithms, which are used to condition the directional input audio signal I_{G} to produce the output audio signal O in order to support the ability of the user to hear. The signal processing algorithm or the signal processing algorithms of the signal conditioning unit 32 are selected for example from algorithms for frequency-selective amplification on the basis of an audiogram of the user, dynamic compression, active noise cancellation, wind noise reduction, feedback suppression, automatic gain control, etc. These algorithms are preferably implemented as software components.

The signal processor 16 preferably also has a signal analysis unit 34. This signal analysis unit 34 comprises algorithms that examine the captured ambient sound (that is to say the input audio signal I) for predefined criteria, e.g. predefined sound classes, signal-to-noise ratio, etc., and variably parameterize the beamformer unit 30 and the or each algorithm of the signal conditioning unit 32 on the basis of the analysis result. The signal analysis unit 34 comprises a voice recognition unit 36 with algorithms for detecting voice activity in general (that is to say the presence of speech in the captured ambient sound, irrespective of the speaker) and possibly the user's own voice in particular.

Optionally, at least one of the hearing instruments 4 further comprises an acceleration sensor 38.

The control app 6 in the exemplary embodiment according to FIG. 2 is designed to convert the speech of other (i.e. other than the user of the hearing system 2) speakers that is potentially contained in the captured ambient sound (and thus in the input audio signals I) into text and to display this text in the style of subtitles in real time on a screen 40 of the smartphone 22. To this end, the control app 6 comprises—in the form of software components—a speech detection unit 42 (also referred to as a speech-to-text converter), a voice analysis unit 44 and a text composing and editing unit 46.

During operation of the hearing system 2, the input audio signals I are continually examined by the voice recognition unit 36 for whether the captured ambient sound contains voice activity that does not come from the user themself; the voice recognition unit 36 recognizes this for example from the fact that a voice activity detector of the voice recognition unit 36 provides a positive check result while an own voice detector of the voice recognition unit 36 does not respond. This check is either performed in both hearing instruments 4 independently of one another or alternatively only by the voice recognition unit 36 of one of the two hearing instruments 4, which in this case preferably evaluates the input audio signals I of both hearing instruments 4.

In the case cited above, in which voice activity that does not come from the user themself is detected in the captured ambient sound, the voice recognition unit 36 of at least one of the hearing instruments 4 causes the signal processor 16 (and in this case in particular the signal conditioning unit 32) to wirelessly relay the output audio signal O to the control app 6 via the data transmission connection 24. Furthermore, the control app 6 receives from the at least one hearing instrument 4 the origin signal R from the beamformer unit 30 and—if available—an acceleration signal B from the acceleration sensor 38.

The speech detection unit 42 converts the speech contained in the output audio signal O into text data T. The voice analysis unit 44 identifies at least one speaker trait S, e.g. the estimated sex and/or the estimated age of the respective speaker, on the basis of specific traits of the speech sound, in particular the voice timbre and/or the tonal pitch of the speech sound. On the basis of the at least one speaker trait S, the voice analysis unit 44 additionally distinguishes different speakers from one another by interpreting distinct changes in the at least one speaker trait S as an indication of a change of speaker. Additionally, the voice analysis unit 44 preferably uses the origin signal R and/or the acceleration signal B for this purpose by inferring a change of speaker from an abrupt change in the origin signal R associated with the speech sound and/or from a head rotation in response to a change of direction of the speech sound. The voice analysis unit 44 delivers a speaker identification signal F, together with the or each identified speaker trait S, to the text composing and editing unit 46, which flags the respective identified speaker.

In the example according to FIG. 2, the text composing and editing unit 46 uses the text data T to create a graphical representation G, for display on the screen of the smartphone 22, that contains the text and helps the user of the hearing system 2 to better understand the speech heard from the other speakers. To assist the user particularly effectively in this, the text composing and editing unit 46 graphically represents individual passages of the text data T that can be associated with different speakers according to the speaker identification signal F in a different form (and thus one that is easily distinguishable by the user).

By way of example, the text composing and editing unit 46 displays such passages of the text data T that can be associated with different speakers in different text boxes 48. Optionally, the text boxes 48 are displayed in different colors that are characteristic of the respective speaker. Further optionally, the text composing and editing unit 46 selects the respective color of the text boxes T according to the at least one speaker trait S. As such, the text composing and editing unit 46 associates a red shade with a speaker identified as female on the basis of the voice analysis, for example, whereas it associates a blue shade with a speaker identified as male on the basis of the voice analysis.

As another measure for easily associating the individual text boxes 48 with, if appropriate, multiple speakers, the text composing and editing unit 46 takes the origin signal R as a basis for arranging a direction-indicating symbol of each text box 48 (in this case in the form of an arrow 50) in such a way that the position of this symbol on the screen 40 indicates the arrangement of the speaker associated with the text box 48 in relation to the user. In the case of text boxes 48 that are associated with a speaker standing to the left of the user, the arrow 50 is displayed in the left-hand region of the text box 48. In the case of text boxes 48 that are associated with a speaker standing to the right of the user, the arrow 50 is displayed in the right-hand region of the text box 48. In the case of text boxes 48 that are associated with a speaker standing opposite and in front of the user, the arrow 50 is displayed centrally with respect to the text box 48.

In addition or as an alternative to immediate display of the text boxes 48 on the screen 40, the control app 6 records the graphical representation G in a memory of the smartphone 22 for later output on the smartphone 22 or another device.

In time intervals in which the user themself is speaking (and in which the voice recognition unit 36 therefore recognizes the user's own voice in the captured ambient sound), the output audio signal O is preferably not forwarded to the control app 6. In this case, the speech sound is accordingly also not converted into text data T and said data are not graphically displayed on the screen 40.

FIG. 3 schematically shows an alternative configuration of the hearing system 2 in which the graphical representation G of the text data T acquired from the speech sound is produced as a virtual reality application. The variant embodiment according to FIG. 3 corresponds to the embodiment from FIG. 2, apart from the differences that are outlined more precisely below. As a departure from the latter embodiment, however, a camera 52 of the smartphone 22 is used, according to FIG. 3, to capture a real image sequence V (that is to say a video of the real surroundings of the user) and to display it in real time (preferably with a delay of no more than 0.5 second) on the screen 40 of the smartphone 22.

To graphically represent the text data T acquired from the speech sound, the text composing and editing unit 46 in the example according to FIG. 3 puts the passages of text associated with each speaker (other than the user) into speech bubbles 54, which the text composing and editing unit 46 inserts into the real image sequence V close to the depiction of the associated speaker or sound-generating object (radio, television, etc.), in this case according to the origin signal R. The text composing and editing unit 46 arranges a speech bubble stem 56 of the speech bubble 54 in such a way that the speech bubble stem 56 points to the person who is speaking or the sound-generating object. To permit better association of the speech bubbles 54 with the respective associated sound source, the control app 6 preferably utilizes an image recognition unit 58, connected downstream of the camera 52, that automatically recognizes heads of depicted persons or other sound sources in the real image sequence, for example. In this case, the control app 6 preferably utilizes a standard function of the camera app of the smartphone 22 as the image recognition unit 58.

In the variant embodiment of the hearing system 2 according to FIG. 3, too, the graphical representation G of the text data T, in this case that is to say the real image sequence V with the inserted speech bubbles 54, can, in addition or as an alternative to immediate display on the screen 40, be recorded by the control app 6 in a memory of the smartphone 22 for later output on the smartphone 22 or another device.

FIG. 4 shows another variant embodiment of the hearing system 2, which in turn corresponds to the variant embodiments according to FIGS. 2 and 3 with the exception of the differences described below. As a departure from the latter embodiments, there is provision in the variant embodiment according to FIG. 4 for sonic composing and editing of the text data T in the form of synthesized speech L instead of graphical written composing and editing of the text data T.

In this regard, the text composing and editing unit 46 in the variant embodiment according to FIG. 4 comprises a speech synthesis unit 60 and a stereophonic sound generation unit 62. The speech synthesis unit 60 converts the text data T into the synthesized speech L. On the basis of the at least one identified speaker trait S and the speaker identification signal F, the speech synthesis unit 60 generates the synthesized speech L for different identified speakers using respective different associated artificial voices. In particular, the speech synthesis unit 60 generates the synthesized speech L for each of the different identified speakers using a voice that is similar to the real voice of this speaker according to the at least one speaker trait F. As such, for example passages of text that are associated with one (female) speaker are synthesized using a female-sounding voice, while passages of text that are associated with one (male) speaker are synthesized using a male-sounding voice.

Optionally, each of the individual passages of text is also synthesized using a voice that suits the estimated age of the respective speaker. As such, for example passages of text that are associated with a young speaker are synthesized using a young-sounding voice, while passages of text that are associated with an older speaker are synthesized using an older-sounding voice.

In all cases, the synthesized speech L is preferably generated as standard language with clear articulation. The use of accents, dialects and/or unclear pronunciation is therefore preferably avoided for generating the synthesized speech L.

The speech synthesis unit 60 outputs the synthesized speech L generated in such a manner to the downstream stereophonic sound generation unit 62 in the form of an audio signal. The stereophonic sound generation unit 62 takes the origin signal R as a basis for converting the synthesized speech L into a stereo signal ST having a stereophonic sound characteristic that corresponds exactly or approximately to the stereophonic sound characteristic of the ambient sound. The control app 6 supplies this stereo signal ST back to the hearing instruments 4 (and in this case in particular the signal conditioning units 32), which deliver the stereo signal ST (preferably in real time, specifically with a delay of no more than 0.2 second) to the two ears of the user via the receivers 12 of the hearing instruments 4 in the form of airborne sound.

Due to the stereophonic sound characteristic of the stereo signal ST that is produced by the stereophonic sound generation unit 62, passages of text from a speaker positioned to the left, to the right or in front of the user sound as though the synthesized speech L, from the point of view of the user, were also coming from the left, from the right or from the front. For this conversion, the stereophonic sound generation unit 62 applies in particular a stored head-related transfer function to the synthesized speech L.

During output of the synthesized speech L to the user, the signal conditioning units 32 of the hearing instruments 4 preferably mask out the real captured ambient sound, in particular (and preferably selectively only or to a higher degree) in the frequency range relevant to the captured speech, in order to prevent the synthesized speech L in the output audio signal O from interfering with the real captured speech. Optionally, artificially generated ambient sounds (noise, birdsong, music) are added to the synthesized speech L in order to avoid a sound situation that seems unnatural. In particular a complete soundscape that seems natural is therefore preferably synthesized.

In this variant embodiment of the hearing system 2, too, in addition to or instead of the composed and edited text data T, in this case that is to say the synthesized speech L, being immediately output, the control app 6 can record the synthesized speech L for later output on the smartphone 22 or another device. Moreover, the variant embodiment according to FIG. 4 can be combined with the variant embodiments according to FIGS. 2 and 3 by virtue of the control app 6 optionally causing both the graphical representation G of the text data T and the synthesized speech L to be simultaneously output and/or recorded.

The invention becomes particularly clear from the exemplary embodiments described above, but is in no way limited to these exemplary embodiments. Rather, further embodiments of the invention can be derived from the claims and the description above.

### LIST OF REFERENCE SIGNS

2 hearing system
4 hearing instrument
6 control app
8 housing
10 microphone
12 receiver
14 battery
16 signal processor
18 sound channel
20 tip
22 smartphone
24 data transmission connection
30 beamformer unit
32 signal conditioning unit
34 signal analysis unit
36 voice recognition unit
38 acceleration sensor
40 screen
42 speech detection unit
44 voice analysis unit
46 text composing and editing unit
48 text box
50 arrow
52 camera
54 speech bubble
56 speech bubble stem
58 image recognition unit
60 speech synthesis unit
62 stereophonic sound generation unit
B acceleration signal
F speaker identification signal
G (graphical) representation
(input) audio signal
I_{G} (directional input) audio signal
L (synthesized) speech
O (output) audio signal
R origin signal
S speaker trait
ST stereo signal
T text data
U supply voltage
V real image sequence

1-10. (canceled)

11. A method for supporting the hearing comprehension of a user of a hearing instrument, the method comprising:
using the hearing instrument to capture speech-containing ambient sound from surroundings of the user;
automatically converting speech contained in the captured ambient sound into text data;
outputting the text data to the user as at least one of:
a graphical representation of text on a screen of the hearing instrument or of a peripheral device connected to the hearing instrument for data transmission purposes, or
synthesized speech formed as a sound signal;
automatically determining at least one of a direction of origin or at least one speaker trait for the speech contained in the ambient sound in a manner resolved with respect to time; and
varying the graphical representation of the text data and the synthesized speech based on at least one of the identified direction of origin or the at least one speaker trait in a manner resolved with respect to time.

12. The method as claimed in claim 11, which further comprises outputting the text data and the synthesized speech to the user in real time.

13. The method according to claim 11, which further comprises varying at least one of a display location for the graphical representation of the text data or a direction-indicating symbol associated with the text based on the identified direction of origin in a manner resolved with respect to time.

14. The method according to claim 11, which further comprises producing the graphical representation of the text data in a form of a text insertion into a real image sequence of the surroundings of the user captured during capture of the ambient sound, and locally associating the text insertion with a depiction of a related sound source in the real image sequence.

15. The method according to claim 11, which further comprises varying at least one of a text color, a text size, a font or a background color of an associated text box for the graphical representation of the text data in a manner resolved with respect to time.

16. The method according to claim 11, which further comprises generating the synthesized speech based on the direction of origin as a stereo signal with a stereophonic sound characteristic corresponding exactly or approximately to a stereophonic sound characteristic of the ambient sound.

17. The method according to claim 11, which further comprises varying at least one of a voice timbre or a tonal pitch of the synthesized speech based on the at least one speaker trait in a manner resolved with respect to time.

18. A method for supporting the hearing comprehension of a user of a hearing instrument, the method comprising:
using the hearing instrument to capture speech-containing ambient sound from surroundings of the user;
automatically converting speech contained in the captured ambient sound into text data;
recording the text data as at least one of:
a graphical representation of text, or
synthesized speech in an audio signal,
for later output;
automatically determining at least one of a direction of origin or at least one speaker trait for the speech contained in the ambient sound in a manner resolved with respect to time; and
varying the graphical representation of the text data and the synthesized speech based on at least one of the identified direction of origin or the at least one speaker trait in a manner resolved with respect to time.

19. The method according to claim 18, which further comprises varying at least one of a display location for the graphical representation of the text data or a direction-indicating symbol associated with the text based on the identified direction of origin in a manner resolved with respect to time.

20. The method according to claim 18, which further comprises producing the graphical representation of the text data in a form of a text insertion into a real image sequence of the surroundings of the user captured during capture of the ambient sound, and locally associating the text insertion with a depiction of a related sound source in the real image sequence.

21. The method according to claim 18, which further comprises varying at least one of a text color, a text size, a font or a background color of an associated text box for the graphical representation of the text data in a manner resolved with respect to time.

22. The method according to claim 18, which further comprises generating the synthesized speech based on the direction of origin as a stereo signal with a stereophonic sound characteristic corresponding exactly or approximately to a stereophonic sound characteristic of the ambient sound.

23. The method according to claim 18, which further comprises varying at least one of a voice timbre or a tonal pitch of the synthesized speech based on the at least one speaker trait in a manner resolved with respect to time.

24. A hearing system, comprising:
at least one hearing instrument having at least one input transducer for capturing ambient sound from surroundings of a user, a signal processor for modifying a captured sound signal, and an output transducer for outputting the modified sound signal to the user;
a speech detection unit, an analysis unit and a text composing and editing unit;
said speech detection unit configured to automatically convert speech contained in the captured ambient sound into text data;
said analysis unit configured to determine at least one of a direction of origin or at least one speaker trait for the speech contained in the ambient sound automatically and in a manner resolved with respect to time;
said text composing and editing unit configured to output the text data to the user as at least one of:
a graphical representation of text on a screen of said at least one hearing instrument or of a peripheral device connected to said at least one hearing instrument for data transmission purposes, or
synthesized speech in a form of a sound signal; and
said text composing and editing unit configured to vary the graphical representation and the synthesized speech based on at least one of the identified direction of origin or the at least one speaker trait in a manner resolved with respect to time.

25. A hearing system, comprising:
at least one hearing instrument having at least one input transducer for capturing ambient sound from surroundings of a user, a signal processor for modifying a captured sound signal, and an output transducer for outputting the modified sound signal to the user;
a speech detection unit, an analysis unit and a text composing and editing unit;
said speech detection unit configured to automatically convert speech contained in the captured ambient sound into text data;
said analysis unit configured to determine at least one of a direction of origin or at least one speaker trait for speech contained in the ambient sound automatically and in a manner resolved with respect to time;
said text composing and editing unit configured to record the text data as at least one of:
a graphical representation of text, or
synthesized speech in a form of an audio signal,
for later output; and
said text composing and editing unit configured to vary the graphical representation and the synthesized speech based on at least one of the identified direction of origin or the at least one speaker trait in a manner resolved with respect to time.
